(19) United States
(12) Patent Application Publication
(10) Pub. No.: US 2009/0032626 A1
(43) Pub. Date: Feb. 5, 2009

(54) PLASTIC RECLAIM SYSTEM

(76) Inventors: Steven L. Armstrong, Perry, MI (US); Larry Parmet, Braselton, GA (US); Kevin Murray, Asbury, NJ (US); Jeffrey S. Gottwald, Gainesville, GA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/028,694

(22) Filed: Feb. 8, 2008

Related U.S. Application Data
(60) Provisional application No. 60/888,900, filed on Feb. 8, 2007.

(51) Int. Cl. B02C 23/20; B03B 9/00

(52) U.S. Cl. 241/19; 241/14; 209/44.3; 241/60; 241/75; 241/79; 209/44.2; 209/142

(57) ABSTRACT

Systems and methods are provided for separating materials, such as fluff and plastic found in disposable diapers. A separator unit is provided having an inlet for receiving the materials, means for separating the materials, and multiple outlets for each of the respective materials. In one aspect, the system is substantially pneumatic, and air is used to separate the materials. In some aspects, a shredder is provided for shredding the materials prior to separating, and balers are provided for baling each of the respective materials.

This application claims priority to and the benefit of U.S. Provisional Application No. 60/888,900, filed on Feb. 8, 2007, which is incorporated in its entirety in this document by reference.

### FIELD OF THE INVENTION

This invention relates generally to systems and methods for separating materials, such as those that compose disposable diapers.

### BACKGROUND OF THE INVENTION

In the process of diaper manufacturing, there are often defects in the diapers produced, which prevent the diaper manufacturers from selling their product. The defective diapers, as a rule, are unmarketable and ultimately increase the cost of production due to the loss of valuable raw material. Thus, diaper manufacturers rely on recovery or reclamation of the diaper material to make up for at least a portion of the financial loss. This loss is prevalent in the manufacture of diapers of various sizes (such as newborn, toddler, and adult diapers) and colors.

Diaper manufacturers generally bale the defective diapers to be sent to facilities where the materials can be reclaimed. Often, diaper manufacturers pre-shred the diapers coarsely to prevent them from being sold by others. Diaper manufacturers also often process the diapers once to reclaim at least some of the readily accessible cellulose and super-absorbent polymer (SAP), also known as fluff. However, the bales that are sent to reclamation facilities still contain significant amounts of fluff. The diaper material can further comprise high density polyethylene (HDPE) film, non-woven polypropylene (PP), SPL rubber (such as is found in the waist band of diapers), SAP/fluff, print, colorant, additives, and the like.

Current diaper reclaim systems are unable to effectively separate the fluff from the plastic materials in the disposable diapers. Thus, the byproducts of currently known systems are not sufficiently pure for further use in other systems that use the reclaimed products.

Thus, there is a need in the art for systems and methods for efficiently separating diaper materials to achieve high purity levels in the separated materials so that they can thereafter be recycled or reused.

### SUMMARY OF THE INVENTION

In accordance with the purposes of this invention, as embodied and broadly described herein, this invention, in one aspect, relates to systems for separating materials, such as, but not limited to, materials that compose disposable diapers. In one aspect, the system comprises one or more separator units, each comprising an inlet for receiving the materials, means for separating the materials, and a plurality of outlets for each of the materials that are being separated.

In another aspect, the system comprises one or more of the following: means for shredding the material prior to separating it, means for baling the separated material, means for drawing or driving air through at least a portion of the system, and means for filtering the air being drawn or driven through at least a portion of the system.

In another aspect, the invention relates to methods for separating materials. In one aspect, the method comprises providing at least two materials to a separator unit comprising an inlet configured for receiving the at least two materials, means for separating the materials from each other, a first outlet for a first material and a second outlet for the second material.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate (one) several embodiment(s) of the invention and together with the description, serve to explain the principles of the invention.

FIG. 1 is a schematic diagram of an exemplary plastic reclaim system, according to one aspect of the present invention.

FIG. 2 is a schematic diagram of an exemplary plastic reclaim system, according to another aspect of the present invention.

FIG. 3 is a schematic diagram of an exemplary primary separation system according to one aspect of the present invention.

FIG. 4 is a schematic diagram of exemplary separator units having adjustable draft ports, according to one aspect of the present invention.

FIG. 5 is a schematic diagram of an exemplary separator unit, illustrating the flow of air through such, according to one aspect of the present invention.

FIGS. 6A and 6B, together, are a schematic diagram of a plastic reclaim system, according to yet another aspect of the present invention.

FIG. 7 is a cross-section view of a condenser, according to one aspect of the present invention.

FIG. 8 is a flow-chart illustrating a method of separating materials, according to one aspect of the present invention.

FIGS. 9A and 9B illustrate an exemplified schematic diagram of one exemplified embodiment of the reclaim system of the present invention.

FIG. 10 is a schematic diagram of a plastic reclaim system, according to another aspect of the present invention.

FIG. 11 is a schematic diagram of the plastic reclaim system of FIG. 10, showing the flow of material in a feed clearing stage of a reclaim feed cycle.

FIG. 12 is an exemplary screen image showing the time settings for an exemplary four stages of the reclaim feed cycle, showing a fill stage, a feed clearing stage, a recycling stage, and a bale stage.

FIG. 13 is a schematic diagram of a first plurality of diverter valves that are configured to selectively pass materials, the first plurality of diverter valves being configured to selectively open in response to the relative stage of the reclaim cycle.

FIG. 14 is a schematic diagram of a second plurality of diverter valve present in an exemplary aspect of the invention in which two plastic baler units are utilized, the second plurality of diverter valves being configured to selectively open in response to the selected baler in operation.

FIG. 15 is a exemplary illustration of a separator unit, showing a first pressure sensor in communication with the air surrounding the exterior of the cone and a second pressure sensor in communication with the air within the interior of the cone, and showing a plurality of lines in communication with a pressurized air source that are configured to selectively apply pressurized air thereon at least a portion of the exterior of the cone.

FIGS. 16A and 16B are exemplary screen images showing the pressure differential between the respective first and second pressure sensors in each of eight separator units.

FIG. 17 is an exemplary screen image showing the control settings for an exemplary pressurized air blaster.

FIG. 18 is an exemplary screen image showing the pressure differential over time between the respective first and second pressure sensors in Separator Unit 1. One skilled in the art will appreciate that screen images can be selected as desired for any Separator Unit that an operator selects.

FIG. 19 is an exemplary screen image showing the pressure differential over time between the respective first and second pressure sensors in each of eight separator units.

### DESCRIPTION OF THE PREFERRED EMBODIMENTS

The present invention may be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to a “separator unit” can include two or more such separator units unless the context indicates otherwise.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

Reference will now be made in detail to the present preferred embodiment(s) of the invention, examples of which are illustrated in the accompanying drawings. Wherever possible, the same reference numbers are used throughout the drawings to refer to the same or like parts.

### System Overview

In one aspect of the present invention, a system is provided for separating at least two materials, such as, but not limited to, those materials found in disposable diapers. As previously described, disposable diapers typically comprise cellulose and super-absorbent polymer (SAP), together commonly known as fluff, as well as HDPE film, non-woven PP, SPL rubber, print, colorant, additives, and the like. For simplicity of description, but not intending to be limiting, the materials can generally be categorized as fluff and plastic. However, it is to be appreciated that the materials can comprise more or less than fluff and plastic, or can comprise other components.

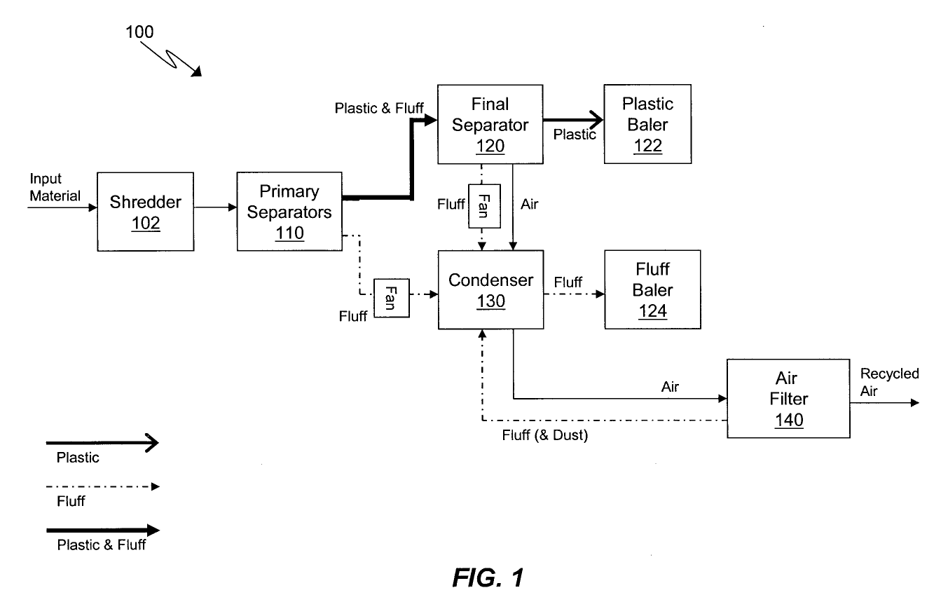

As described above, the disposable diapers or diaper material is typically received by a reclamation facility in the form of a bale that is baled with wire or straps. The bale is then received by the system for processing, such as described in various aspects below. In one aspect, the diaper material is loaded onto a conveyor. If baled, the straps are cut and the bales are conveyed to a de-baler. The de-baler can contain conventional means for holding the bale in position while the diaper material is chipped away from the constrained bale. With reference to FIG. 1, in one aspect, the chipped away diaper material is conveyed or otherwise fed to a shredder 102 configured to shred or cut up the diaper material. Optionally, the shredder can also perform the function of de-baling such that a separate de-baler would not be needed.

The shredded material is then conveyed to one or more separator units 110. According to one aspect, each separator unit comprises an inlet for receiving the input materials and means for substantially separating a first of the materials (such as, but not limited to, fluff) from a second of the materials (such as, but not limited to, plastic). Each separator unit also comprises a first outlet for the first material and a second outlet for the second material. Thus, in one aspect, fluff is passed through the first outlet and plastic is passed through the second outlet. The system also comprises means for baling the first material, such as fluff, in operative communication with the first outlet, and means for baling the second material the second material, such as plastic, in operative communication with the second outlet. Thus, if the two materials are fluff and plastic, the system comprises a fluff baler 124 and a plastic baler 122. In some aspects, the separator unit(s) 110 may separate some, but not all, of the fluff from the plastic. In this aspect, the system can also comprise a final separator 120 configured to further separate the plastic and fluff received from the separator unit(s).

In a preferred aspect, the system primarily relies on air for the separation of the materials and moving the materials to and through the various system components. Accordingly, in one aspect, the system comprises a condenser 130 that is configured, in part, to filter air and remove fluff particles from the air being driven or drawn through the system. The condenser is in operative communication with the first outlet of the primary separator unit(s), and comprises an outlet in operative communication with the fluff baler. The system, in some aspects, further comprises a system air filter 140 configured for filtering the air being driven or drawn through the system and releasing the filtered air to the ambient environment. The system may also include one or more fans (described in greater detail below) for drawing or driving materials through the system. For example, with reference to FIG. 1, a fan may be provided between the separator unit(s) and the condenser 130, to drive the fluff to the condenser.

### Shredder

As described above, in one aspect, the system comprises a shredder 102 configured for shredding the diaper materials that is in operative communication with the inlet of the separator unit(s) 110. The shredder may be any commercially available shredder, such as the RG62 HiTorc™ shredder, available from Vecoplan, LLC (High Point, N.C.). The shredder can also control or meter the material being conveyed to the separator unit(s).

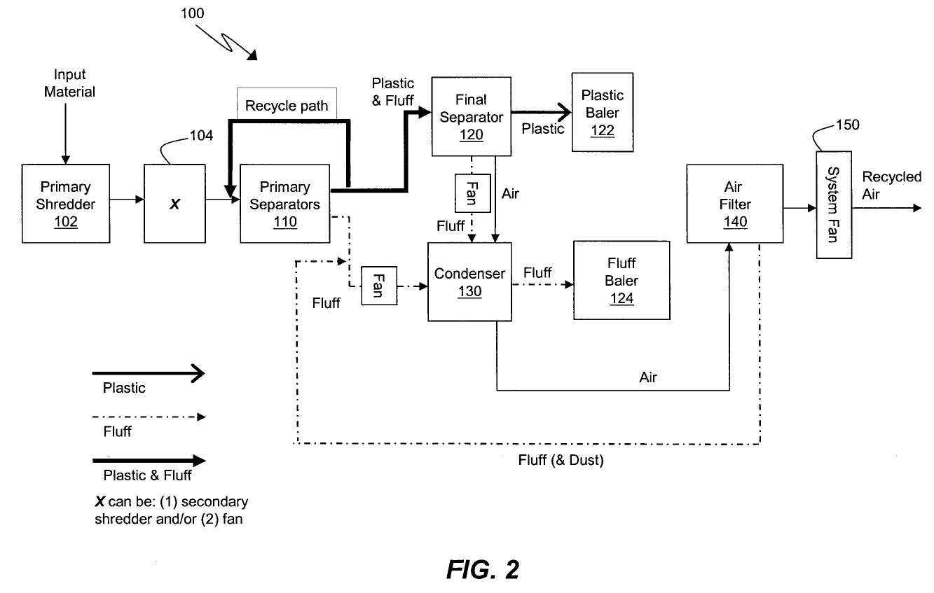

In other aspects, the system comprises a secondary shredder 104 or chop fan that is configured to shred or chop the diaper material into finer pieces, such as is shown in FIG. 2. The shredded diaper material would then be conveyed to the separator unit(s). The secondary shredder or chop fan may be an extraction fan equipped with cutting blades, such as any one of the Chopperline® line chopper fans, available from Delta Neu (Cedex, France).

### Primary Separator Units

In one aspect, the system comprises at least one separator unit that comprises an inlet for receiving the diaper material (such as from the primary shredder 102 or secondary shredder 104). The separator unit also comprises means for separating a first material from a second material, such as separating fluff from plastic. Each of the at least one separator unit also comprises a first outlet for the first material and a second outlet for the second material. Each separator unit comprises a housing and a separation cone positioned within the housing and defining a space between the separation cone and housing for separating the first and second material. A separator unit such as a Model FS400 separator from Ibis International (Hoschton, Ga.), can be used as a suitable separator unit.

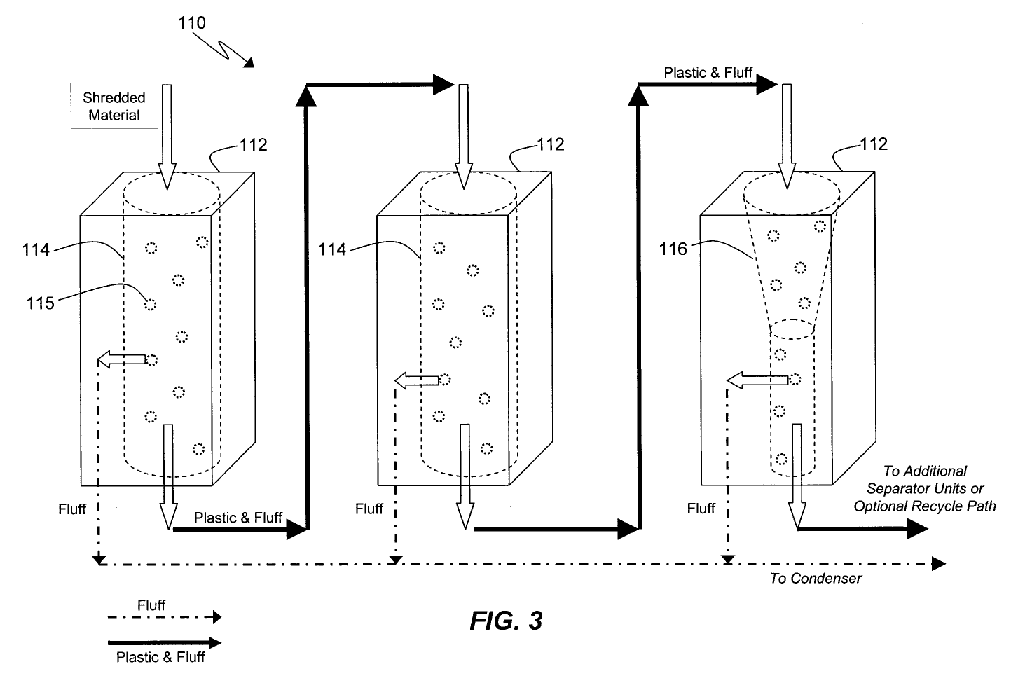

With reference to FIG. 3, the separation cone comprises an upper portion and a lower portion. A separation cone may be substantially cylindrical in both the upper and lower portions, as illustrated by the cylindrical separation cone 114. Optionally, a separation cone may have a frustoconical upper portion, in which the uppermost diameter is larger than the lowermost diameter (i.e., an inverse frustoconical shape), and a substantially cylindrical lower portion having substantially the same diameter as the lowermost diameter of the upper portion, as shown in FIG. 3 as separation cone 116. It is also contemplated that at least a portion of the separation cone can comprise an inverse frustoconical shape. In one aspect, by using a variety of separation cones of varying sizes, the speed of material flow through the separator units can be manipulated to achieve desired levels of separation. In either configuration, the inlet of the separator unit is in operative communication with the upper portion of the separation cone. Thus, if only one separation cone is used, the shredded material will be conveyed from the primary or secondary shredder to the separation cone via the inlet.

Referring to FIGS. 3-5, the separation cone has an outer surface that defines at least one aperture 115 configured to allow movement of at least some of the material to pass from the separation cone to the space therebetween the separation cone and the housing 112. For example, in one aspect, a vacuum source is applied to the separator unit (such as to the space between the separation cone and the housing) so that the fluff is pulled through the at least one aperture. The separation cone is configured to retain the plastic material within the separation cone. The apertures 115 on a given cone may have a consistent size (e.g., diameter). Optionally, the aperture size may vary, such as a first aperture size in an upper portion of a separation cone and a second aperture size in a lower portion of the separation cone. Additionally, aperture size can vary between the separation cones. It is contemplated that in one aspect, the aperture size may range from 0.5 to 2 inches, including the diameters of 0.5, 0.75, 1, 1.25, 1.5, 1.75, and 2 inches, although other ranges are contemplated as falling within the scope of this invention. In a particular aspect, if eight separation cones are provided, the first two in series may have apertures of approximately 1 inch in diameter, and the remaining six separation cones in the series may have apertures of approximately 0.75 inches in diameter.

Optionally, air can be driven into the separation cone so as to drive the fluff through the aperture(s) to the space between the separation cone and the housing, while retaining the plastic within the separation cone. It is contemplated that a vacuum source and means for driving air into the separator unit can be simultaneously applied to the separator unit. A scrap fan, such as the I.E. 11-19-B fan (available from American Fan Company/Woods USA, Fairfield, Ohio), can be used to draw (such as in a vacuum manner) or drive air into the separator unit. Optionally, the system comprises a main system fan (such as system fan 150 shown in FIG. 2) for drawing and/or driving air through all or portions of the system. In such aspect, the vacuum force may be caused by the system fan, without the aid of additional fans. In other aspects, the system fan and additional fans (such as described above) can be used in combination to create a vacuum force or driving force within the separator unit.

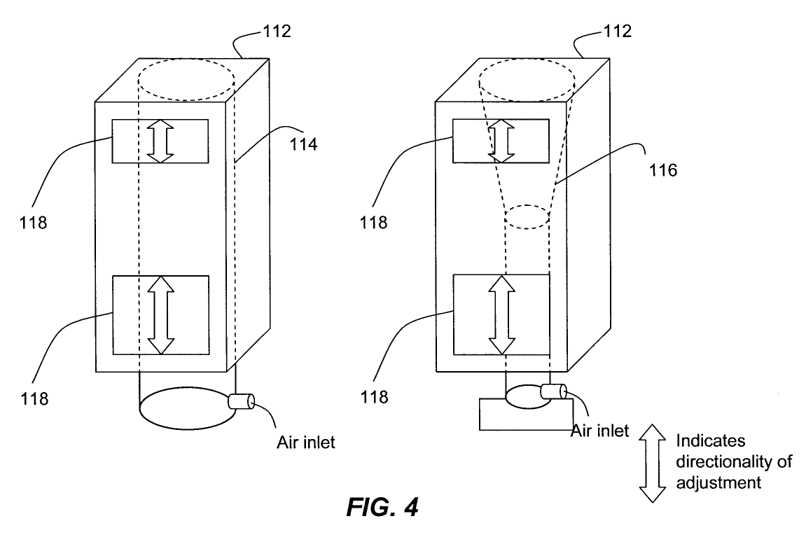

With reference to FIG. 4, each separator unit may comprise one or more adjustable draft ports 118 positioned within one or more walls of the separator unit housing 112. In one aspect, the adjustable draft port(s) is slidably moveable in an up or down manner, so as to allow more or less air to be drafted into the separator unit. Optionally, the adjustable draft port may be slidably moveable in a direction other than up or down, or may be opened in a non-slidable manner. One or more separation cones may also have an air inlet, as shown in FIG. 4, for further manipulating and controlling the flow of air through the separator units.

In one aspect, the system comprises a series of two or more separator units. The system, in one aspect, comprises from about 2 to about 15 units. Optionally, the system comprises from about 5 to about 10 units. In a particular aspect, the system comprises 8 separator units. In such aspect, the system may comprise separator units 114 all having a substantially cylindrical shape, separator units 116 all having an inverse frustoconical upper portion and cylindrical lower portion, or a combination of both in any order. For example, in a particular aspect, the system comprises a series of four separator units having cylindrical separation cones followed by a series of four separator units having frustoconical and cylindrical separation cones.

If two or more separator units are used, the inlet of the first separator unit, such as shown in FIG. 3, is configured to receive the shredded material. The fluff is then separated from the plastic. As may be appreciated, the first separator unit may only separate some of the fluff from the plastic. Thus, the separated fluff is driven and/or drawn out of the separator unit via a first outlet that is in operative communication with the space between the housing 112 and the separation cone 114, such as in a lower portion of the separator unit. The plastic and fluff that remains within the separation cone is driven or drawn out of the separator unit via a second outlet that is in operative communication with the interior of the separation cone. In one aspect, the second outlet is in operative communication with the lower portion of the separation cone. In some aspects, the first outlet and second outlet are positioned within a bottom surface of a separator unit. Optionally, the first and second outlet may be positioned elsewhere along the housing of the separator unit. The plastic and fluff are then conveyed to the inlet of a second separator unit, as shown in the diagram. The separation process is repeated by subsequent separator units to remove more fluff from the plastic and fluff mixture. Thus, at each separation stage, more fluff is removed from the fluff and plastic mixture. At each subsequent separator unit, the fluff is conveyed out of a respective first outlet, and the plastic (along with any remaining fluff) is conveyed out of a respective second outlet to a subsequent separator unit (or a final plastic separator, as discussed below). As discussed above, any number of separator units can be used to achieve optimal separation of fluff from plastic. As may be appreciated, fans may be used to drive the plastic (along with any fluff) from the outlet of one separator unit to the inlet of another separator unit.

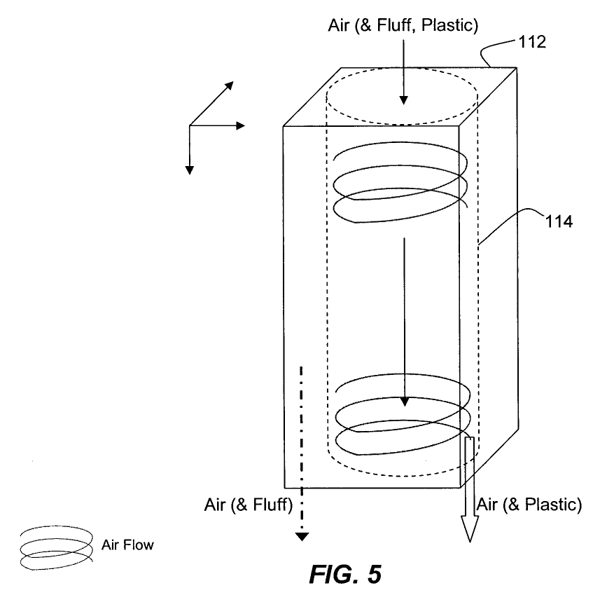

FIG. 5 illustrates the exemplary flow of air through the separation cone 114 of a separator unit. In one aspect, the air being driven and/or drawn through the separation cone moves in a swirling, downward motion. As discussed above, some of the air, along with fluff, is driven or drawn into the space between the separation cone and housing, and exits the separator unit via a first outlet. Some of the air, along with plastic (and any remaining fluff), remains within the separation cone and exits via a second outlet. As may be appreciated, the swirling motion of the air flow may be clockwise or counterclockwise. In other embodiments, the airflow may be upward rather than downward, or in other directions. Similarly, the air may flow in something other than a swirling motion. It is contemplated that, in various aspects, a material purity of greater than 95%, such as from about 96% to 99%, can be achieved by using one or more separator units, and an optional final separator unit.

### Condenser

As described above, the fluff separated from plastic in each of the separator units is passed through a first outlet of each separator unit. In one aspect, each of the first outlets is in operative communication with a fluff baler. Optionally, the fluff is first passed to a condenser 130. The first outlets may be in operative communication with the condenser via a common conduit or conveyor, or via separate conduits or conveyors. In one aspect, a first series of four separator units may have first outlets all in operative communication with a first conduit, and a second series of four separator units may have first outlets all in operative communication with a second conduit. Fans may be used to blow or drive the fluff through the conduit(s). Fans, such as the I.E. 26-MH fan of American Fan Company/Woods USA (Fairfield, Ohio), are suitable for this purpose.

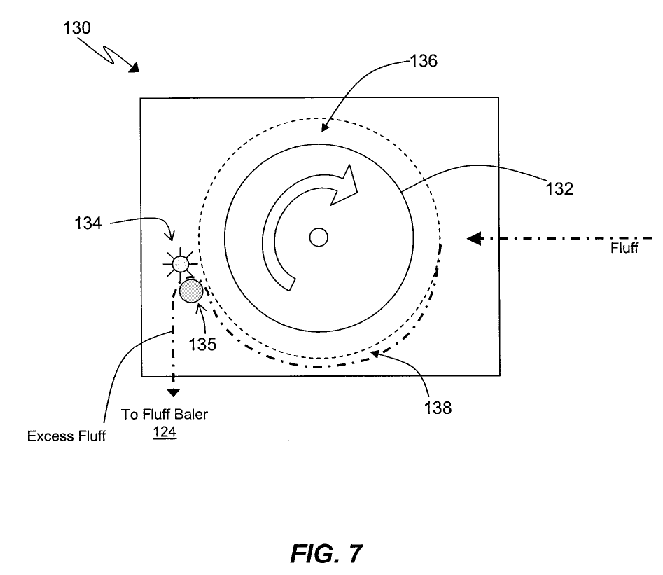

The condenser comprises an inlet configured for receiving the fluff from the one or more conduits or conveyors. With reference to FIG. 7, the condenser in one aspect further comprises a drum 132 for filtering fluff from the air. The drum may comprise a mesh or screen, comprised of, for example and without limitation, metal. The condenser may comprise a vacuum source adapted to pull or draw fluff onto the surface of the drum. Thus, a mat 136 of fluff surrounds at least a portion of the drum. Air and fine particles are filtered through the fluff and the mesh surface of the drum. Some or all of the fluff may be doffed off of the surface of the drum and passes through a first condenser outlet to the fluff baler 124. The fluff may be doffed off when a differential pressure between the outside and inside of the drum reaches a preset level, such as between 2 and 4 inches of water differential pressure. In one aspect, the thickness of the mat is controlled by maintaining a specific water pressure such as, but not limited to, 3 inches of water differential pressure. The thickness of the mat can vary from approximately 0 inches thick to approximately 1 inch thick, in one aspect, including the thickness of 0.25, 0.5, 0.75 and 1 inches.

Optionally, or in addition to the pressure control described above, the condenser may comprise means for maintaining a uniform, predetermined thickness of the mat. The predetermined thickness can range from a substantially negligent amount of fluff, to several millimeters or inches thick. For instance, the condenser may comprise a solid roller 135 configured to compress the mat against the drum surface. A doffing roller 134 may be positioned in operative relation to the solid roller and may be configured to maintain the predetermined mat thickness by doffing off the excess fluff. In this aspect, the drum is configured to rotate about an axis substantially parallel to the longitudinal axis of the condenser (indicated by the curved arrow in FIG. 7, although the rotation can be clockwise or counterclockwise). As the drum rotates, the doffing roller will make contact with any fluff exceeding the pre-determined thickness and will doff off the excess fluff 138.

As discussed above, all or some of the fluff passing through the condenser will be passed via the first condenser outlet to the fluff baler 124. The condenser also comprises a second condenser outlet in communication with the inner portion of the drum 132 configured for the passage of air. The air will be driven or drawn to the air filter 140, described further herein below. A suitable condenser is the 72×54 FAF 11 Style 3 condenser, available from Continental Conveyor and Equipment Company (Winfield, Ala.).

### Fluff Baler

In various aspects, fluff passes from the primary separator unit(s) to the fluff baler 124. In other aspects, the fluff passes from the primary separator unit(s) to the condenser, and then to the fluff baler. The baler is configured to bale the fluff, such as for sale on the secondary market. A suitable baler may be a horizontal baler, such as the HL-12-X-HDM baler available from Harris Waste Management Group, Inc. (Peachtree City, Ga.). As may be appreciated, fluff bales or plastic bales and mini-bales (described below) can be wrapped (e.g., stretch wrapped, shrink wrapped, etc.) in a conventional manner, such as by using the H206-072-1138 AV bale wrapper from Highlight Industries (Grand Rapids, Mich.).

### Final Plastic Separator

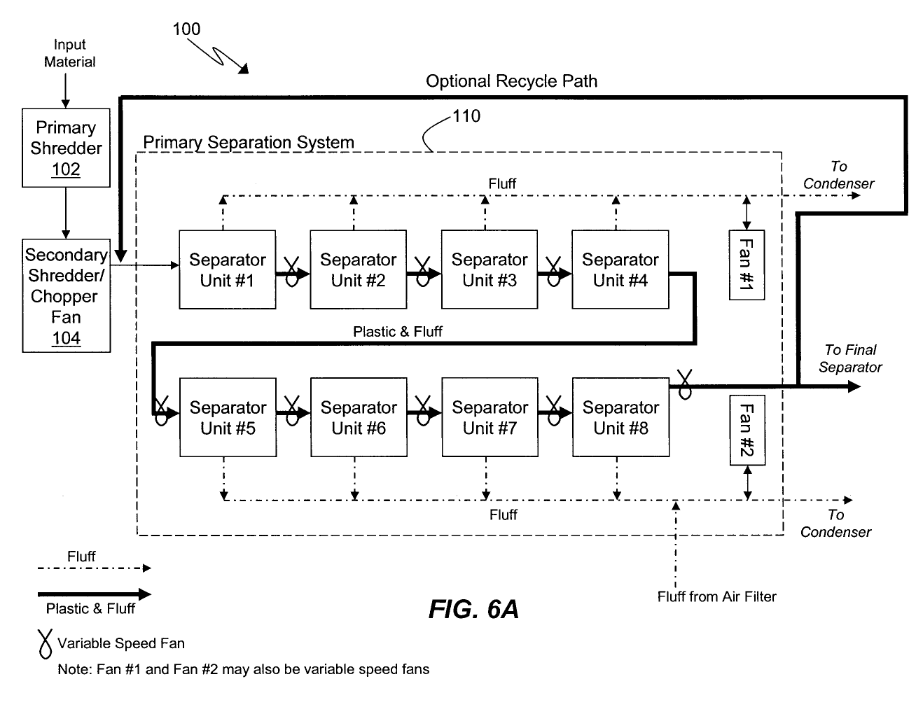

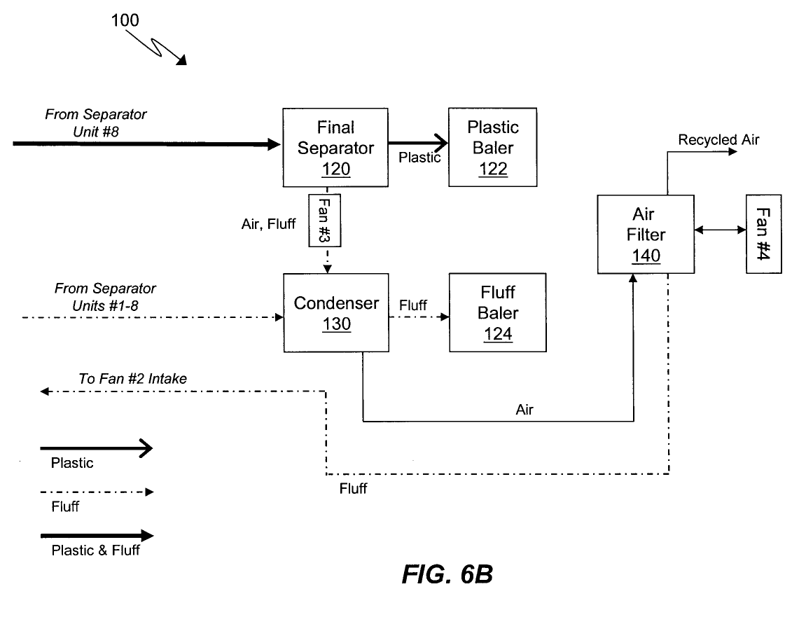

As described above, plastic (and any additional fluff) passes through the second outlet of each separator unit. In one aspect and as illustrated in FIGS. 2 and 6A, at the final primary separator unit 110 the plastic (and any remaining fluff) may be conveyed through an optional recycle path back to the inlet of the first primary separator unit for further processing and refinement. Optionally, in another aspect, after the final primary separator unit, the plastic (and any remaining fluff) may be conveyed to a final separator 120. In one aspect, the final separator comprises a container with a curved screen or mesh on a rear portion. In use, a vacuum source (such as air being drawn from the final separator via the condenser) pulls air and any remaining fluff through the curved screen. As can be seen in FIG. 2, a fan may be used to drive the remaining fluff to the condenser 130. The separated plastic is then wiped off of, or otherwise removed from (such as by using a rotor blade), the screen and is metered to the plastic baler 122.

### Plastic Baler

In various aspects, plastic passes from the second outlet of the final separator unit of the series of primary separator units 110 to a desired or selected plastic baler 122. Optionally, the plastic passes through a final separator 120 for additional fluff/plastic separation, and is thereafter passed to the plastic baler. In one aspect, a mini-baler may be used for creating mini-bales that are used in the production of reusable plastic pellets, as described in U.S. patent application Ser. No. 11/466,040 entitled “System and Method for Recycling Using Waste Stream Products”, filed Aug. 21, 2006, which is incorporated in its entirety herein by reference. A suitable mini-baler is the HRB-14N 40 HP mini-baler available from Harris Waste Management Group, Inc. (Peachtree City, Ga.).

### Components of Pneumatic System

As described above, in various aspects, the system of the present invention is substantially a pneumatic system. Air may be driven or drawn through the system via one or more fans, such as system fan 150, which is configured to draw air through some or all of the system components. With reference to FIG. 6A, the system may comprise any number of additional fans, such as fans in operative communication with each separator unit. In one aspect, these fans are variable speed fans. Each of these variable speed fans is configured to draw or drive air into the separator units to aid in the separation of fluff and plastic. In a further aspect, it is contemplated that a differential pressure transmitter can be mounted prior to the variable speed fans for measuring the pressure differential from atmosphere to the variable speed fan suction. In this aspect, and as one skilled the art will appreciate, the measured differential can be used to determine the flow rate being fed into the respective variable speed fan (and into the subsequent stage of the process). These fans may also be configured to drive plastic from the outlet of one separator unit to the inlet of the consecutive separator unit. Optionally, or in addition, one or more fans may be provided in series with the separator units, such as, for example and without limitation, Fan #1 and Fan #2 shown in FIG. 6A. In one aspect, Fan #1 and Fan #2 may also be variable speed fans. Fan #1 and Fan #2 may be used to drive fluff to the condenser, as described above. Optionally, Fan #3, as exemplarily shown in FIG. 6B, may be configured to drive the fluff to the condenser 130. As may be appreciated, any number of fans may be used, and can be activated or deactivated depending on the needs and settings of the particular system.

In one aspect, the system comprises an air filter 140 for filtering the air being driven and/or drawn through the system. The air filter in one aspect comprises a drum. The drum may be substantially large, having a length in the range of about 100 to 200 inches, and a diameter of 50 to 100 inches. In one particular aspect, the drum is approximately 163-164 inches in length and about 83 inches in diameter. In another aspect, the drum is approximately 95 inches in diameter. The drum may be sized for approximately 32,000 to 40,000 CFM, 100 to 150 FPM. In one aspect, the drum comprises a metal mesh covered with a filter media “blanket”. A suitable drum filter is the Model 7-6 filter of Ibis International. The drum is in operative communication with a vacuum source (such as, but not limited to, Fan #4 or system fan 150) such that the “blanket” surface is adapted to pull fine dust from the condenser 130 and other system components.

In operation, the drum rotates and a series of fixed nozzles is activated via a diverter valve to pull material off of the drum surface and into a nozzle fan which sends the dust to a cartridge collector for final collection and disposal into a waste container. Optionally, any additional fluff particles pulled off of the drum surface can be fed back to the condenser and processed as described above. Material sent to the cartridge collector is collected on a fiber or paper cartridge, which is periodically pulse cleaned using compressed air from the clean air side of the cartridge collector. Material dropping off of the contaminated side of the cartridge due to the pulse cleaning drops through a rotary airlock into a collection container.

Any remaining particulate matter in the air that has passed through the drum filter “blanket” is captured on secondary filtration cartridges, which are periodically pulse cleaned from the clean air side of the drum filter. The material which is removed from the contaminated side of the series of secondary filtration cartridges drops onto the floor of the secondary filtration chamber for later removal. Finally, air passing through the series of air filters (e.g., the drum and filter cartridges) is drawn by the system fan 150 to the ambient environment. It is contemplated that this air is 99.5% (or higher) particulate-free down to 0.4 microns. The system fan may be operated by a variable speed drive so that it can be adjusted to accommodate the current parameters or state of the system.

### Additional System Components

As may be appreciated, the system according to various aspects of the present invention may comprise additional components or instrumentation, such that the system can be controlled partially or fully automatically. For example, sensors may be installed on or within various system components: optical sensors within the duct work or conduits (such as to monitor for jams or clogs); optical sensors on the fiber baler and plastic baler; and pressure sensors or instrumentation on each separator unit. It is contemplated that each system component can be controlled manually, automatically, or a combination of both. For example, logic can be implemented to control each component individually or in combination with other system components. As an example, logic may be implemented to increase or decrease pressure within the separator unit(s) in the case of a material jam or clog, or to modulate the flow of material between potions of the system components.

Other components may be used to maintain stable functionality of the system. For example, clean outs can be installed in the separator units and/or the ducts and conduits of the system to allow for easy removal of clogs or jams. In this aspect, the clean outs can be placed in such a way that the system need not be fully or partially shut down in the case of a jam or clog.

### Method of Use

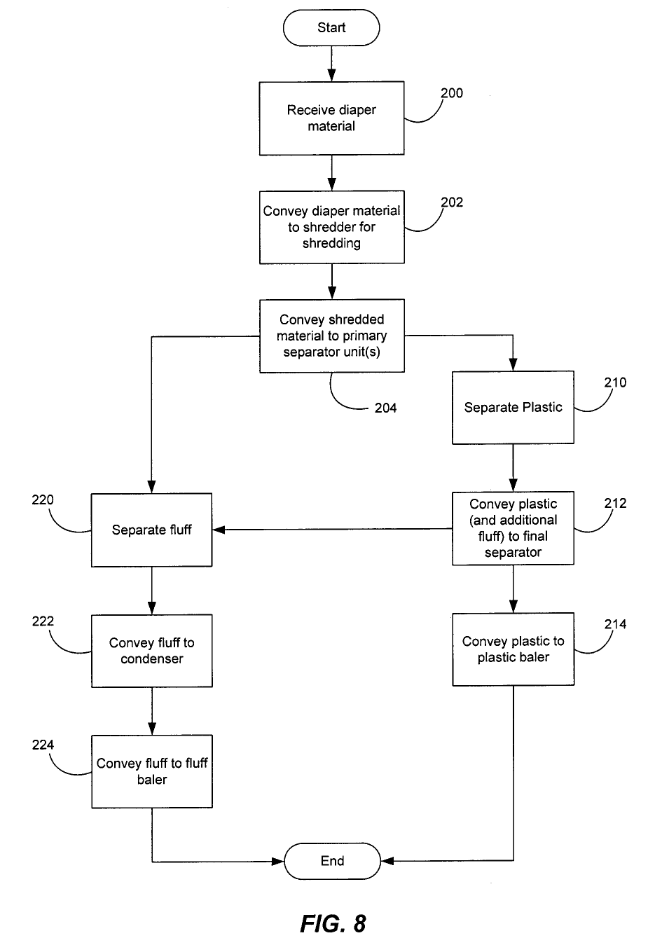

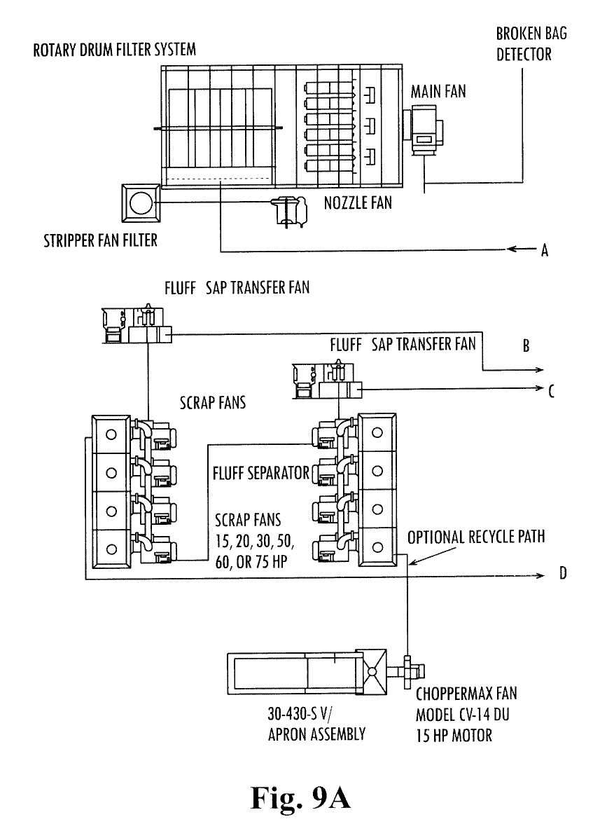

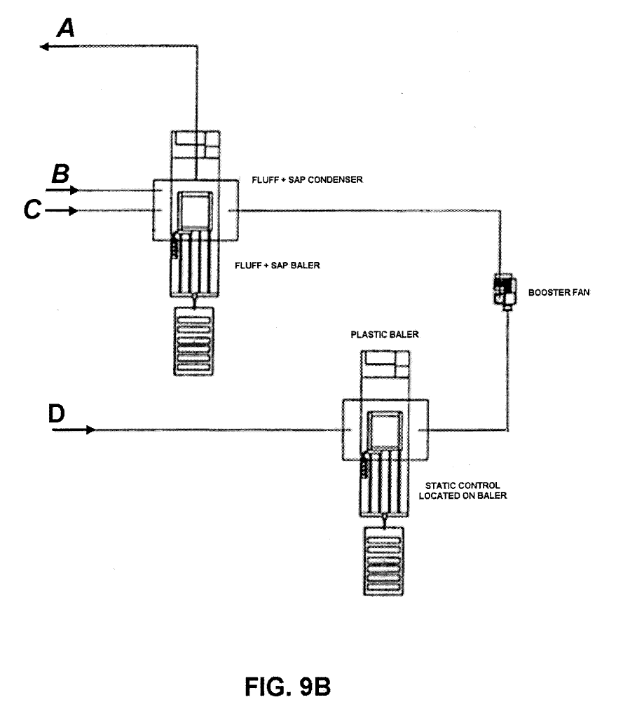

In one aspect, a method is provided for separating materials, such as those found in disposable diapers. In one aspect, a system substantially as described above may be used to implement one or more steps of the method, as described throughout. With reference to FIG. 8, the method begins with receiving the diaper material 200. As described herein, the diaper material may be received from a diaper manufacturer in bale form, boxed form, or other form, and the diaper material may be substantially whole, or may be pre-shredded. At step 202, the diaper material is conveyed, provided or otherwise fed to a shredder for shredding. At step 204, the shredded material is then conveyed to one or more primary separator units. Optionally, the shredded material may be conveyed to a second shredder or chopper fan for additional shredding.

The shredded material is separated by the one or more primary separator units into the respective diaper materials, such as fluff and plastic. Thus, at step 210, the plastic is separated from the fluff, and at step 220, the fluff is separated from the plastic. In one aspect, these steps are performed substantially simultaneously. For example, a separator unit may be provided for separating the materials and comprises an inlet for receiving the materials (such as, but not limited to, the shredded material), means for separating the materials, and a first and second outlet for respective first and second materials (such as, but not limited to, fluff and plastic, respectively).

As described above, in one aspect the separator unit comprises a housing and separation cone for separating the materials. The separation cone is positioned within the housing and defines a space between the separation cone and the housing. The space may be configured for receiving separated fluff, such as through one or more apertures in the separation cone, and is in operative communication with the first outlet. The separation cone comprises an upper portion that is in operative communication with the inlet, and a lower portion in operative communication with the second outlet. The step of separating the materials may also comprise driving or drawing air into the separator unit to agitate or vacuum the materials, respectively, via air communication means.

At step 222, the separated fluff is conveyed to the condenser, and thereafter is conveyed at step 224 to a fluff baler. The separated plastic (and any additional fluff) is conveyed to a final separator at step 212. Additional fluff is separated at step 220, and is conveyed to the condenser along with previously separated fluff. The separated plastic is conveyed to a plastic baler at step 214. In one aspect, the fluff may be conveyed directly to the fluff baler without passing through a condenser.

In one aspect, the method also comprises providing a system fan configured for drawing or driving air through one or more components of the system. For example, the system fan may be configured for drawing air through the separator unit(s), to assist in the separation process for example. Optionally, drawing air through the separator unit(s) may assist in moving the materials from the separator unit to additional separator units or other system components. An air filter may also be provided for filtering the air being driven or drawn through the system. The system fan, or an additional fan, may be configured to release the filtered air into the ambient environment.

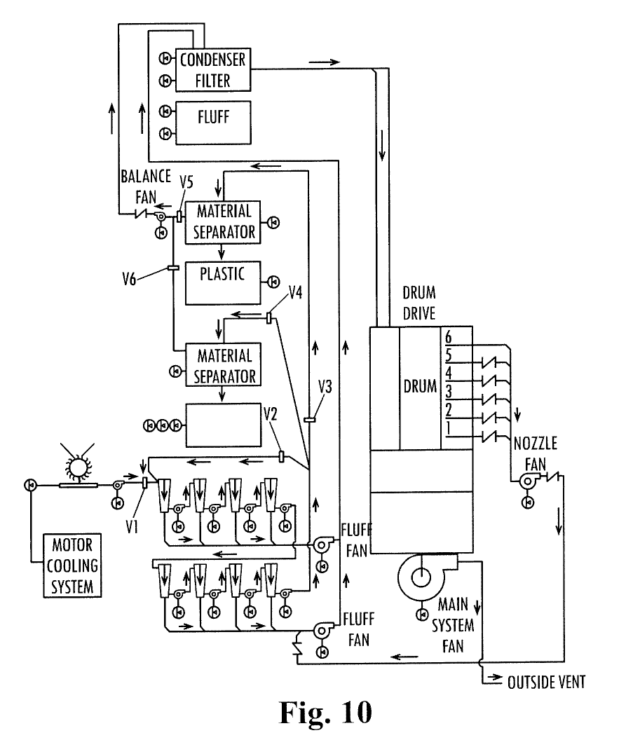

Referring now to FIG. 10, in an alternative embodiment of the present invention for a plastic reclaim system, a plurality of diverter valves 300 are provided that are configured to be selectively controlled such that material flow through the various portion of the reclaim system can be selectively controlled. In this aspect, it is contemplated that the material can be at least partially recycled through the separator unit(s) 110 such that a desired purity of reclaim plastic can be realized. In various aspects, the exemplified plastic reclaim system can generate reclaimed material plastic that is at least 85% pure, preferable at least 90% pure, and more preferably at least 95% pure.

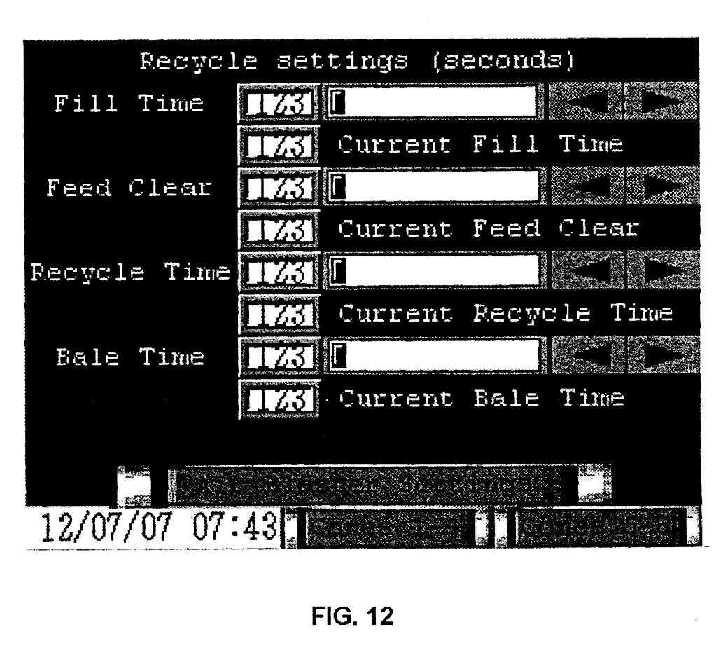

In this aspect of the system, the flow of material though the separator unit(s) 110 can be controlled in a four stage reclaim cycle. In one exemplary aspect, and as shown in FIG. 12, the reclaim cycle can comprise a fill stage, a feed clearing stage, a recycling stage, and a bale stage. In one aspect, each respective stage can be sequentially run for a predetermined period of time. FIG. 12 illustrates an exemplary screen image showing time settings for the four stages of the reclaim cycle, showing the first fill stage, the second feed clearing stage, the third recycling stage, and the fourth bale stage.

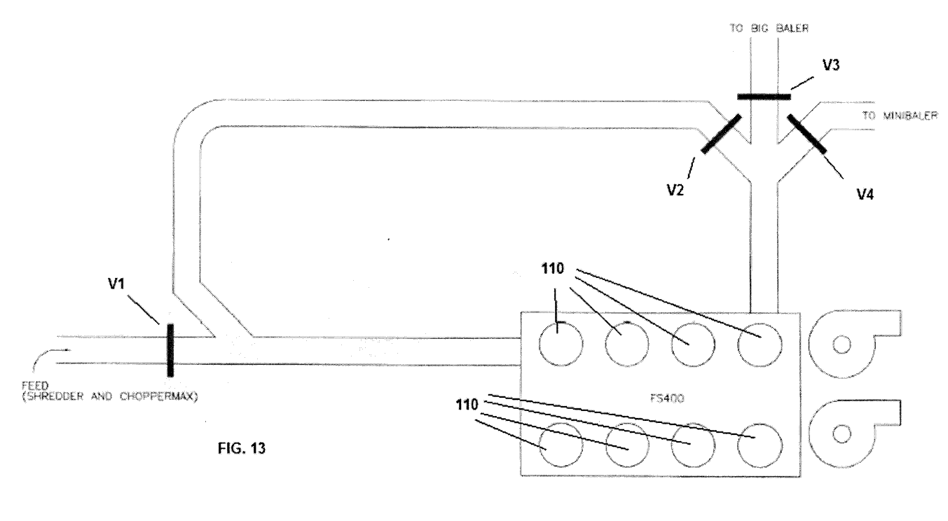

In one embodiment, the plurality of diverter valves 300 can comprise a first plurality of diverter valves 302 (diverter valves V1, V2 and V3). Referring to FIGS. 10 and 13, the first plurality of diverter valves are configured to selectively pass materials therebetween selected portions of the recycling system. In one aspect, the first plurality of diverter valves is configured to selectively open in response to the relative stage of the reclaim cycle.

In one aspect, diverter valve V1 is positioned in a raw feed line extending between the shredder 102 and the material intake of the first separator unit 110. Diverter valve V2 is positioned in a recycle feed line that is in communication with the material exhaust of the final sequential separator unit and the raw feed line. In one aspect, the recycle feed line joins the raw feed line between the diverter valve V1 and the material intake of the first separator unit. Diverter valve V3 is positioned in a bale feed line that is in communication with the recycle feed line and an intake of the final separator 120 of the plastic baler 122. The bale feed line joins the recycle feed line intermediate diverter valve V2 and the exhaust of the final separator unit. The first plurality of diverter valves 302 can also comprise diverter valve V4 that is positioned in a mini-bale feed line in communication with the recycle feed line and an intake of the final separator 120 of a second plastic baler 122. The mini-bale feed line joins the recycle feed line intermediate diverter valve V2 and the exhaust of the final separator unit.

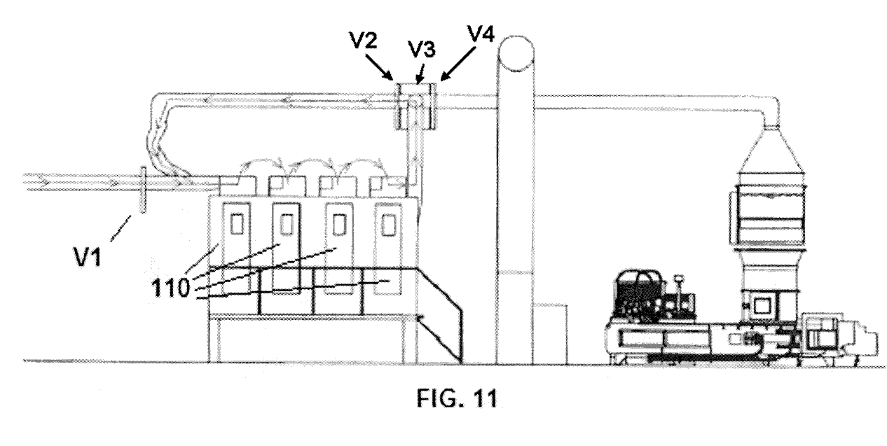

In operation, for a predetermined time during the fill stage, the shredder 102 is actuated and diverter valve V1 is opened to allow for material from the shredder to be fed to the separation units. Diverter valve V2 is positioned in an open position to allow for material to be recycled as the unit is filling. In the fill stage, diverter valves V3 and V4 are positioned closed. For a predetermined time in the subsequent feed clearing stage, the shedder 102 is turned off so that no new material is inserted into the feed line. Diverter valves V1, V2, V3, and V4 remain in their respected fill stage positions during the feed clearing stage. FIG. 11 illustrates an exemplary flow of reclaim material in the feed clearing stage of the reclaim cycle.

In the subsequent recycling stage, diverter valves V1, V3 and V4 are positioning closed. However, diverter valve V2 stays open so that material can be cycled repeatedly through the separator unit(s) 110 for a predetermined period of time. After the time period for the recycling stage lapses, the bale stage is initiated. In this bale stage, diverter valves V1 and V2 are closed and either one of diverter valves V3 or V4 is opened so the one of the baler units can be selectively fed. As one skilled in the art will appreciate, it is contemplated that after the time for the baling stage has elapsed, the system automatically will reinitiate the feed stage of the reclaim cycle.

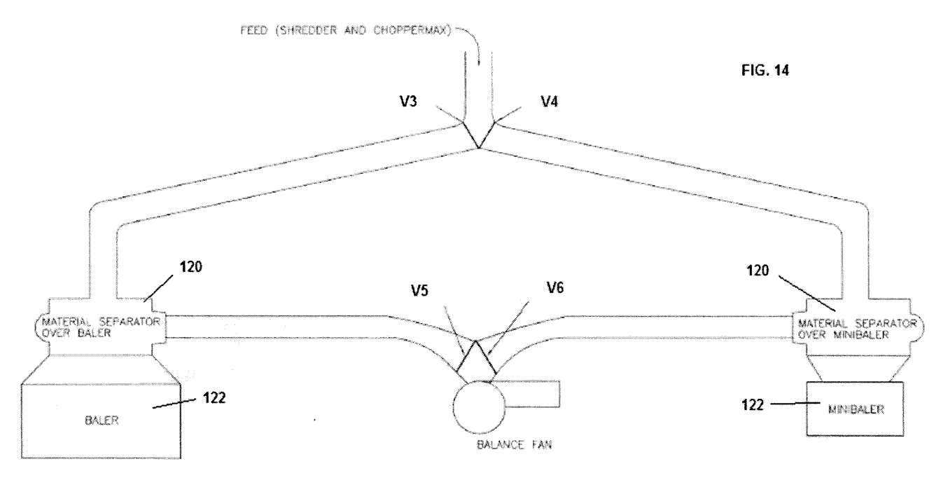

It is contemplated that the plurality of diverter valves 300 can also comprise a second plurality of diverter valves 304 that are configured to selectively open in response to the selected baler in operation. In the embodiment illustrated in FIGS. 10 and 14, in which two plastic balers are utilized, the second plurality of diverter valves 304 comprises diverter valves V5 and V6. In this exemplary aspect, diverter valve V5 is positioned in the line running from the material separator of a first baler unit to the balance fan. Similarly, diverter valve V6 is positioned in the line running from the material separator of a second baler unit to the balance fan. In operation, diverter valve V5 or V6 is positioned open if its respective baler is in use. If the baler is not being used, the respective diverter valve V5 or V6 is positioned closed.

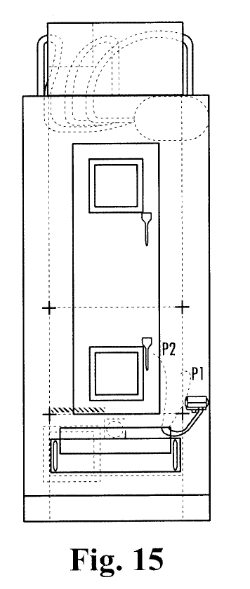

Referring now to FIG. 15, an exemplary illustration of a separator unit 110 is shown in which a first pressure sensor P1 is positioned in communication with the air surrounding the exterior of the separation cone 114 and a second pressure sensor P2 is positioned in communication with the air within the interior of the separation cone. In one aspect, the first pressure sensor and the second pressure sensor can, for example, be a differential pressure transmitter, such as by using the Sensocon Model A 2010-02 differential pressure transmitter. Further, a plurality of pressure lines or pressurized air blasters in communication with a pressurized air source is provided. In one aspect, the distal end of at least one pressure line of the plurality of pressure lines is positioned to selectively direct or blast pressurized air onto at least portions of the outer surface of the separation cone to aid in precluding the blockage of the separation cone with entrained material. In another aspect, the distal end of at least one pressure line of the plurality of pressure lines is positioned to selectively direct or blast pressurized air onto at least portions of the inner surface of the separation cone. As one skilled in the art will appreciate, it is contemplated that the respective pressure lines can be positioned to “blast” either select inner surfaces of the separation cone, select outer surfaces of the separation cone, or any desired combination of inner/outer surfaces of the separation cone.

It is contemplated that the distal end of each pressure line of the plurality of pressure lines can comprise a nozzle that can be moved to selectively select the application of pressurized air. In one aspect, the nozzle can be automatically controlled to select a preferred pattern or pressure of the applied pressurized air.

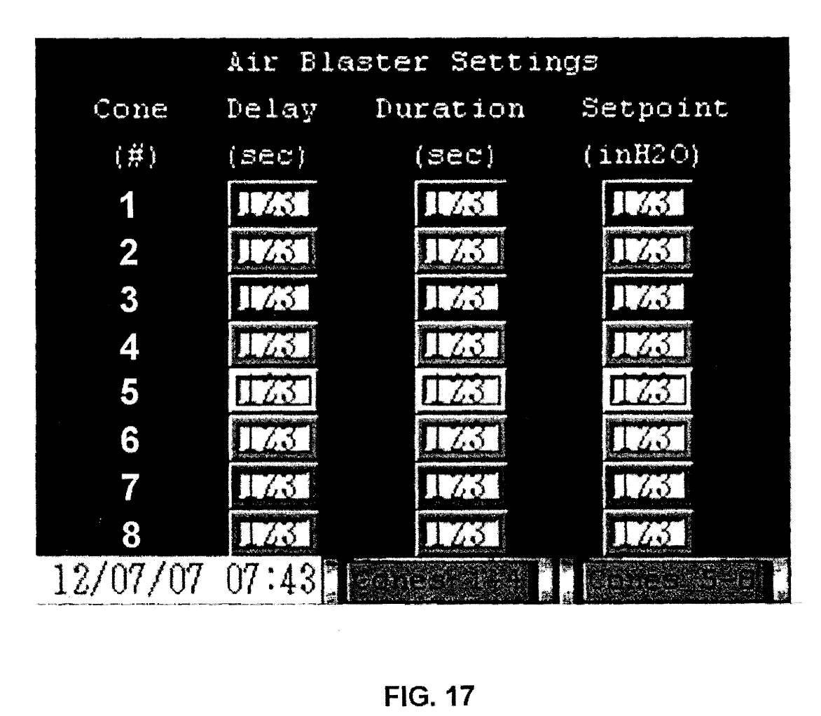

It is contemplated, in one aspect, that the first and second pressure sensors can provide feedback such that the pressurized air can be actuated from respective pressure lines in response to a noted differential between pressures sensed by the respective first and second pressure sensors. In another aspect, it is contemplated that pressurized air can be actuated from respective pressure lines in response to a noted expiration of a predetermined time period between actuations. In yet another aspect, it is contemplated that pressurized air can be actuated from respective pressure lines in response to either a noted differential between pressures sensed by the respective first and second pressure sensors or a noted expiration of a predetermined time period between actuations. FIG. 17 illustrates an exemplary screen image showing the settings for the pressurized air blaster, the delay time, duration of the blast, and the differential between pressures sensed by the respective first and second pressure sensors required to trigger a blast.

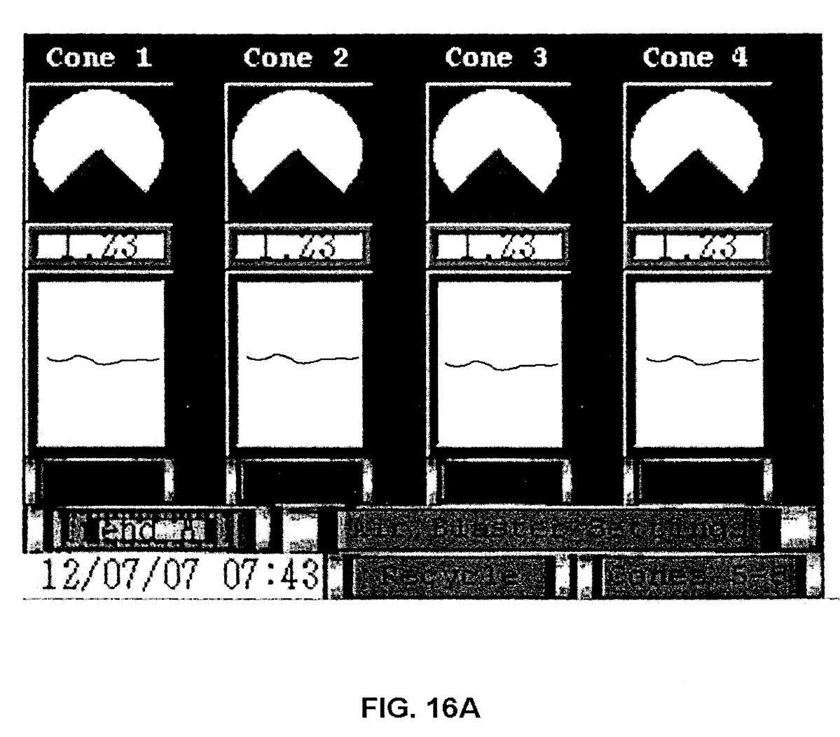

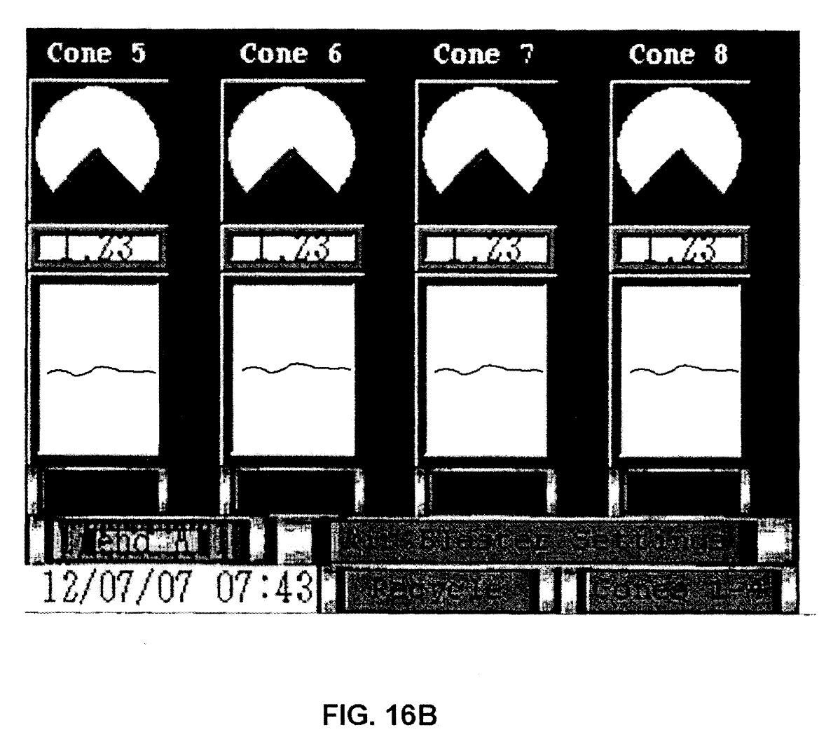

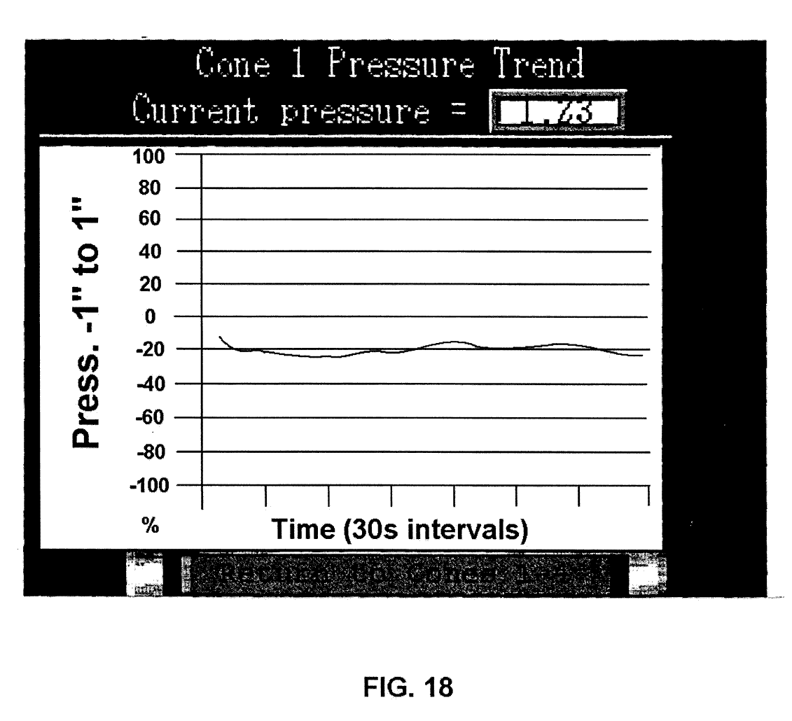

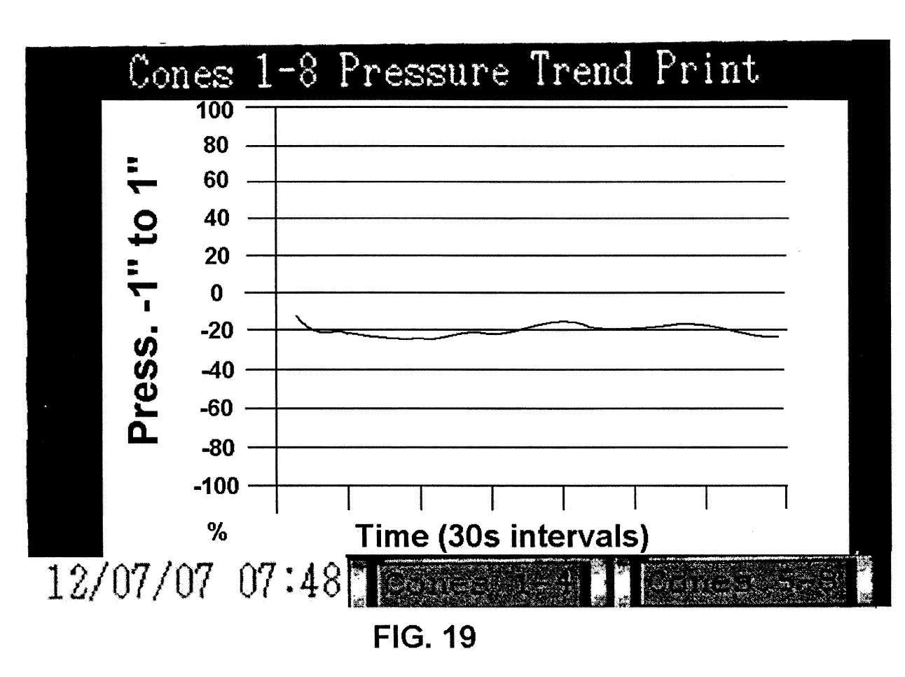

Referring to FIGS. 16A and 16B, screen images are shown that exemplarily illustrate the pressure differential between the respective first and second pressure sensors P1, P2 in each of separator units 110 of an eight separator unit system. In one aspect and as exemplary illustrated in FIG. 18, the pressure differential between the respective first and second pressure sensors for one of the eight separator units can be illustrated over time in a screen image. One skilled in the art will appreciate that screen images can be selected as desired for any separator unit that an operator selects. This differential pressure, over time, for each of eight separator units is summarized in the screen image of FIG. 19.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for separating at least two materials, comprising:
at least one separator unit, comprising:
an inlet configured for receiving the at least two materials;
means for substantially separating a first of the at least two materials from a second of the at least two materials;
a first outlet for the first material; and
a second outlet for the second material.

2. The system of claim 1, wherein the means for substantially separating the first and second material comprises:
a housing; and
a separation cone positioned within the housing and defining a space therebetween the separation cone and the housing, the separation cone having an outer surface.

3. The system of claim 2, wherein the separation cone has an upper portion and a lower portion and defines an interior, and wherein the inlet is in operative communication with the upper portion of the separation cone.

4. The system of claim 3, wherein the outer surface of the separation cone defines at least one aperture configured to allow movement of at least some of the first material to pass from the interior of the separation cone to the space therebetween the separation cone and the housing.

5. The system of claim 4, wherein the first outlet is in operative communication with the space therebetween the separation cone, and the housing and the second outlet is in operative communication with the lower portion of the separation cone.

6. The system of claim 2, wherein the means for substantially separating the first and second material further comprises:
air communication means for driving air into at least a portion of the separator unit and agitating the at least two materials.

7. The system of claim 1, further comprising:
a shredder configured for shredding the at least two materials, the shredder in operative communication with the inlet of the separator unit.

8. The system of claim 1, further comprising:
means for baling the first material in operative communication with the first outlet; and
means for baling the second material in operative communication with the second outlet.

9. The system of claim 1, further comprising a system fan configured for drawing air through the system.

10. The system of claim 9, further comprising a filter configured for filtering the air drawn through the system.

11. The system of claim 1, further comprising at least one fan configured for driving air through at least a portion of the system.

12. The system of claim 1, wherein the first material substantially comprises fluff and the second material substantially comprises plastic.

13. The system of claim 1, wherein the at least one separator unit comprises from two to ten separator units.

14. The system of claim 1, wherein the at least one separator unit comprises eight separator units.

15. The system of claim 1, further comprising a condenser unit comprising:
a condenser inlet in operative communication with the first outlet of the at least one separator unit;
a filter drum configured for filtering air from the first material, the filter drum having an outer surface;
a mat surrounding at least a portion of the filter drum, the mat comprising the first material;
a first condenser outlet for the first material; and
a second condenser outlet for the air.

16. The system of claim 15, wherein the condenser unit further comprises means for maintaining a uniform, predetermined thickness of the mat.

17. The system of claim 16, wherein the means for maintaining the thickness of the mat comprises a scraper.

18. The system of claim 1, further comprising means for selectively controlling the flow of the at least one material through select portions of the system.

19. The system of claim 18, wherein the means for selectively controlling the flow of the at least one material comprises means for recycling the at least one material to obtain a desired purity of reclaimed plastic.

20. The system of claim 19, wherein the means for recycling the at least one material to obtain a desired purity of reclaimed plastic comprises a four stage reclaim cycle.

21. The system of claim 20, wherein the four stage reclaim cycle comprises a fill stage, a feed clearing stage, a recycling stage and a bale stage.

22. The system of claim 21, wherein the means for selectively controlling the flow of the at least one material comprises a first plurality of diverter valves configured to selectively open in response to the relative stage of the reclaim cycle.

23. The system of claim 5, further comprising at least one first pressure sensor and at least one second pressure sensor, wherein one first pressure sensor is positioned therebetween the outer surface of the separation cone and the housing of each separator unit, and wherein one second pressure sensor is positioned in communication with the air within the interior of the separation cone of each separator unit.

24. The system of claim 23, further comprising a plurality of pressure lines in communication with a pressurized air source, each pressure line having a distal end positioned and configured to selectively direct air onto at least portions of the outer surface of the separation cone.

25. The system of claim 23, further comprising a plurality of pressure lines in communication with a pressurized air source, at least one pressure line of the plurality of pressure lines having a distal end positioned and configured to selectively direct air onto at least portions of an inner surface of the separation cone.

26. The system of claim 25, wherein at least one pressure line of the plurality of pressure lines has a distal end positioned and configured to selectively direct air onto at least portions of the outer surface of the separation cone.

27. The system of claim 24, further comprising feedback means for selectively actuating air from respective pressures lines of the plurality of pressure lines in response to a predetermined differential between pressures sensed by the respective first and second pressure sensors.

28. The system of claim 27, wherein the feedback means for selectively actuating air from respective pressures lines of the plurality of pressure lines actuates in response to an expiration of a predetermined time period between actuations.

29. A method for separating at least two materials, comprising:
providing the at least two materials to a first separator unit comprising:
an inlet configured for receiving the at least two materials;
means for substantially separating a first of the at least two materials from a second of the at least two materials;
a first outlet for the first material; and
a second outlet for the second material.

30. The method of claim 29, wherein the means for substantially separating the first material from the second material comprises:
a housing; and
a separation cone positioned within the housing and defining a space therebetween the separation cone and the housing, the separation cone having an outer surface.

31. The method of claim 30, wherein the separation cone has an upper portion and a lower portion and defines an interior, and wherein the inlet is in operative communication with the upper portion of the separation cone.

32. The method of claim 31, wherein the outer surface of the separation cone defines at least one aperture configured to allow movement of at least some of the first material to pass from the interior of the separation cone to the space therebetween the separation cone and the housing.

33. The method of claim 32 wherein the first outlet is in operative communication with the space therebetween the separation cone, and the housing and the second outlet is in operative communication with the lower portion of the separation cone.

34. The method of claim 30, wherein the means for substantially separating the first and second material further comprises:
air communication means for driving air into at least a portion of the separator unit and agitating the at least two materials.

35. The method of claim 29, further comprising:
driving air into the first separator unit at a force sufficient to agitate the first and second materials.

36. The method of claim 29, further comprising:
shredding the at least two materials, said step occurring prior to the step of providing the at least two materials to the first separator unit.

37. The method of claim 29, further comprising:
conveying the first material from the first outlet to a first material baler; and
conveying the second material from the second outlet to a second material baler.

38. The method of claim 29, wherein the second material comprises at least some of the first material, the method further comprising:
conveying the first material from the first outlet to a first material baler; and
conveying the second material from the second outlet to a second separator unit comprising:
an inlet in operative communication with the second outlet;
means for substantially separating the first material from the second material;
an outlet for the first material; and
an outlet for the second material.

39. The method of claim 29, further comprising:
providing a system fan configured for drawing air through the first separator unit.

40. The method of claim 29, further comprising:
providing an air filter configured for filtering the drawn air; and
releasing the filtered air into the ambient environment.

41. The method of claim 29, further comprising selectively controlling the flow of the at least one material through select portions of the system.

42. The method of claim 41, wherein the step of controlling the flow of the at least one material comprises recycling the at least one material to obtain a desired purity of reclaimed plastic.

43. The method of claim 42, wherein the step of recycling comprises a reclaim cycle having a fill stage, a feed clearing stage, a recycling stage and a bale stage.

44. The method of claim 43, further comprising selectively opening respective diverter valves configured to selectively open in response to the relative stage of the reclaim cycle.

45. The method of claim 33 further comprising positioning a first pressure sensor is therebetween the outer surface of the separation cone and the housing of each separator unit and positioning a second pressure sensor in communication with the air within the interior of the separation cone of each separator unit.

46. The method of claim 45, further comprising:
providing a plurality of pressure lines in communication with a pressurized air source; and
selectively positioning the distal end of each respective pressure line proximate the outer surface of each respective separation cone.

47. The method of claim 46, further comprising selectively actuating air from respective pressures lines of the plurality of pressure lines in response to a predetermined differential between pressures sensed by the respective first and second pressure sensors.
